(19) United States
(12) Patent Application Publication
(10) Pub. No.: US 2002/0130280 A1
(43) Pub. Date: Sep. 19, 2002

(54) Excimer radiator, especially UV radiator

(76) Inventor: Silke Reber, Gelnhausen (DE)

Correspondence Address: FULBRIGHT & JAWORSKI, LLP, 666 FIFTH AVE, NEW YORK, NY, 10103-3198, US

(21) Appl. No.: 10/075,816

(22) Filed: Feb. 13, 2002

(30) Foreign Application Priority Data
Mar. 15, 2001 (DE) 101 12 900.9-33

(51) Int. Cl. G01J 1/00

(52) U.S. Cl. 250/504 R

(57) ABSTRACT

In an excimer radiator, especially an UV radiator with dielectrically impeded discharge, a first electrode is applied in a discharge chamber sealed from the ambient atmosphere onto an elongated support which, as seen in a radial direction from its longitudinal axis, is surrounded by a discharge vessel of quartz defining the discharge chamber; on the outside of the discharge vessel a second electrode is disposed which is permeable to at least a portion of the radiation produced in the discharge chamber.

In order to maintain sufficient stability in the incandescent processes necessary in the manufacture of the radiator in spite of the elongated internal electrode, one end of the support (8) of the first electrode is placed and affixed in a hollow body-like section (5) tapering as seen in longitudinal section, while the other end of the support (8) is connected to a base (11) which has at least one current lead-through (16) for the first electrode (9).

### BACKGROUND AND SUMMARY OF THE INVENTION

The invention relates to an excimer radiator, especially an ultraviolet radiator, with dielectrically impeded discharge, wherein, in a discharge chamber sealed off from the ambient atmosphere a first electrode is applied to an elongated support which is surrounded, as seen in a radial direction from its longitudinal axis, by a discharge vessel of dielectric material permeable to radiation, a second electrode being disposed on the outer side of the discharge vessel which is permeable to at least a portion of the radiation produced in the discharge chamber.

In EP 0 254 111 A1 there is disclosed a high-power radiator which has a discharge chamber filled with noble gas or gas mixture and defined by a metal electrode cooled on one side and a dielectric, wherein both the dielectric and the other electrode lying on the surface of the dielectric facing away from the discharge chamber are transparent to radiation produced by static electrical discharges. In this manner a large-area ultraviolet radiator of high efficiency is created which can be operated with great electrical power densities up to 50 kW/m² of active electrode surface.

Also, an ultraviolet excimer radiator for the treatment of broad substrates is disclosed in DE 41 40 497 A1.

In known radiator systems, the comparatively high expense involved in a cooling system for cooling in the interior of the radiator is problematical.

A high-power radiator, especially for ultraviolet light, is disclosed in DE 42 35 743 A1, which has a discharge chamber filled with a gas which emits radiation under discharge conditions, the outside wall of the discharge chamber being formed at least in part by a first dielectric tube that is transparent to the radiation. The dielectric tube is provided on its surface facing away from the discharge chamber with metallic grid-like or mesh-like external electrodes, while at least a second electrode running in the lengthwise direction of the tube is provided, which bears a protective coating, the dielectric being preferably pinched closed at both ends. In another embodiment, several second electrodes are disposed off-center from the longitudinal axis of the discharge chamber. A radiator constructed in this manner is easy to cool and has a long useful life.

Furthermore, a discharge lamp for operation by dielectrically hindered discharge is disclosed in WO 00/62330 A1, wherein the lamp has a discharge vessel whose wall surrounds an ionizable filling; also, electrodes are provided of which at least one is disposed in the interior and at least one on the external wall of the discharge vessel; furthermore, at least one external power supply is provided, and the at least one internal electrode is connected through the lamp base to the external power supply in a gas-tight manner. The lamp has a fastening means whereby the base is fastened to the lamp foot, a space being provided between the base and the external wall of the discharge vessel.

The invention is addressed to the problem of devising an excimer radiator with an elongated internal electrode, which retains sufficient stability in the annealing processes necessary in the manufacture of the radiator, even without external cooling measures.

Furthermore, the stabilization of shape and supporting function are to be assured in the case of a first or internal electrode with an applied coating, especially a metal coating.

The problem is solved by the invention in that the end of the support of the first electrode is placed in a hollow body-like section that tapers, as seen in longitudinal section of the discharge vessel and is fixed and centered, while the other end of the support is joined to a base which has at least one power lead-through for the first electrode.

It proves to be advantageous that, on account of the quartz tube serving as support the internal electrode is stable in shape and centered, and this arrangement has proven valuable especially in a pulsed excimer radiator.

Furthermore, great stability can be achieved even over long periods of operation.

Additional advantageous embodiments of the invention are specified in claims 2 to 24.

Advantageously, the hollow body-like section is tapered conically.

In a preferred embodiment of the invention the elongated support has an electrically insulating surface on which the material for the first electrode is applied. The support for the internal electrode has a cavity which communicates through a gas connection with the discharge chamber. Advantageously, the support is in the form of a quartz tube.

Furthermore, in a preferred embodiment, the base is joined hermetically to the circumferential margin of the discharge vessel. Preferably, the discharge vessel as well as the base consists of quartz glass, the base being joined by fusion to the discharge vessel in the form of a quartz glass bulb.

In a first advantageous embodiment, an outwardly directed tubular section is attached to the hollow body-like section inside of the discharge vessel to serve as a pump connection which is provided for connection to a pumping and metering apparatus; it proves to be advantageous in this case that the hollow body-like section is sufficiently affixed to and centered on the support on the one hand, which is configured as a quartz tube, but a hermetically tight seal is not created, so that through the outwardly leading tubular section, both the air from the interior of the discharge vessel and, in some cases, of the elongated support, is pumped out, and the filling gas can be fed in for the later operation. After the discharge vessel is filled, the tubular section of the discharge vessel serving at first as a pump connection can be fused shut to so as to seal the interior of the discharge vessel.

In a second advantageous embodiment, the support, which is hollow on the inside, extends out through a center opening in the conically tapering, hollow body-like section of the discharge vessel, the center opening being hermetically sealed by fusion against the outside surface of the support passing through it; the portion of the support that is brought through the opening is configured as a pump connection and designed for connection to a pumping and metering apparatus.

Furthermore, the part of the support that extends outwardly serves the first (or internal) electrode also as a fusible connection for the procedure of sealing the discharge vessel.

In a first embodiment of the internal or first electrode, the latter is a spiral coil of a metal wire disposed on the support. The first electrode is then preferably a coil of nickel-chrome wire.

The coil proves to be especially advantageous, especially during production, since it can be simply slipped over the support for the first electrode or the support can simply be slipped into the coil.

In a second embodiment of the first electrode, the latter is in the form of a metal mesh on the elongated support. The metal mesh consists preferably of monel metal (alloy of nickel with copper and manganese).

In a third embodiment the first electrode is applied as an electrically conductive coating, preferably a thick coating, on the elongated support; the applied coating contains substantially metal, especially noble metal.

In a first embodiment of the external electrode the second electrode is a metal mesh on the external surface of the discharge vessel; the applied metal mesh consists substantially of monel metal (nickel alloy containing 30-32% copper and 1% manganese.

In a second embodiment, the second electrode is a spiral metal coil on the external surface of the discharge vessel; it consists preferably of nickel-chrome wire.

In a third embodiment, the second electrode is at least partially an electrically conductive coating on the external surface of the discharge vessel; in that case the second electrode consists substantially of metal, especially noble metal; the coating is at least mostly permeable to the radiation produced in the discharge vessel.

Gold or a gold alloy is used preferably as the noble metal.

In an advantageous embodiment of the invention, the elongated support of the inner electrode is a hollow body whose interior has a gas connection to the discharge chamber, the interior of the support being designed to bear getter material.

The subject of the invention is further explained hereinbelow with the aid of FIGS. 1 and 2.

### BRIEF DESCRIPTION OF THE FIGURES

FIG. 1 is a side elevation of an excimer radiator in a first embodiment, just before it is pumped down and pinched off, and a quartz tube designed for connection to a pumping and metering apparatus directly adjoins the tapering hollow body-like section of the discharge vessel.

FIG. 2 shows a cross section through the discharge vessel along the line AA of FIG. 1.

FIG. 3 shows a side elevation of an excimer radiator in a second embodiment, similar to FIG. 1, but in contrast to FIG. 1, the quartz tube designed for connection to a pumping and metering apparatus is formed by an outwardly prolonged part of the support for the first or internal electrode.

### DETAILED DESCRIPTION

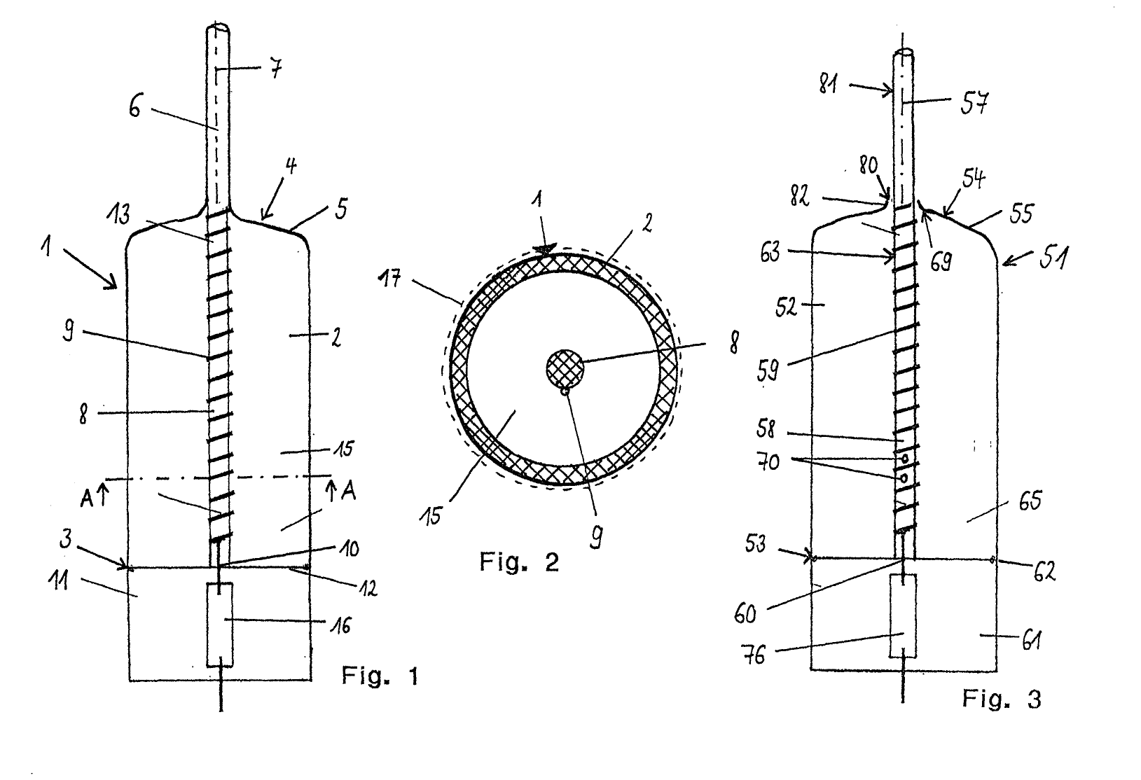

According to FIG. 1, the discharge vessel 1 has a hollow cylindrical part 2 which terminates at one end in an open, annularly circumferential margin 3, while the end 4 remote from the open margin 3 has a hollow body-like, conically tapering section 5 which opens into a hollow quartz tube 6 of reduced diameter. The discharge vessel 1 has in its interior a support 8 in the form of a quartz tube formed along a longitudinal axis 7 in order to bear an internal electrode in the form of a coil of metal wire wound around it as the first electrode 9. Contact is made between the first electrode 9 and a power lead-through 16 through the base 11 by means of a connecting bridge 10. The material of the coil 9 formed on the quartz tube serving as support is preferably nickel-chrome or nickel-chrome wire. It is also possible, however, to form the first or internal electrode by applying to the quartz tube a coating of conductive material or by a metal mesh of monel metal or noble metal.

In spite of the elongated internal electrode, in order to maintain sufficient stability during the annealing processes necessary during the manufacture of the radiator without resorting to external cooling, one end of the support 8 of the first electrode is inserted into the hollow body-like section 5 of the discharge vessel 1, which tapers as seen in longitudinal section, and is centered therein.

The end of support 8 toward the open end at the margin 3 of the discharge vessel 1 is connected to the base 11 which also consists of quartz glass, and which is fused, at its margin 12 facing the discharge vessel, to the circumferential margin 3 of the discharge vessel. The end 13 of the quartz glass tube or support 8 that is remote from the base 11 is inserted into the more or less conically tapering hollow body-like section 5 of the discharge vessel 1 and thus it is held and centered along the axis 7 against radial shifting.

Since the support 8 is thus loosely held, the internal atmosphere of the discharge chamber 15 can be pumped out through the quartz glass 6 of the discharge vessel 1, and replaced with a gas for the discharge—for example xenon with a cold filling pressure of a few millibars or Pa up to 981 mbar or 98.1 KPa, preferably a cold fill pressure of ≦300 mbar or 30 KPa. However, it is also possible to use gas mixtures containing noble gas as the filling gas. After the filling process the discharge vessel is hermetically sealed by fusion or pinching around the quartz glass tube 6, the same as before at the bottom margin 3.

According to FIG. 2, the coil 9 represented in cross section as the interior electrode is situated on the support 8 which is in the form of a quartz glass tube, and it is conformed to the support 8. At a distance from the first electrode or coil 9, the cylindrical portion 2 of the discharge vessel 1 can be seen, which is shown in cross section, and which hermetically seals the discharge chamber 15 from the outside atmosphere. On the exterior of the discharge vessel 1, in the cylindrical portion 2, there is a symbolically represented layer 17 which is the second electrode. It is also possible, however, to use a second electrode composed of a coil or a metal mesh on the cylindrically shaped external surface of discharge vessel 1.

A coating 17 to serve as a second or external electrode consists preferably of an electrically conductive thick film containing noble metal, preferably gold.

It is furthermore also possible to apply a second electrode by PVD (Physical Vapor Deposition), flame spraying, cathode sputtering or printing.

According to FIG. 3, the discharge vessel 1—like the arrangement in FIG. 1—has a portion 52 of hollow cylindrical shape, which terminates at one end in an open, annularly surrounding margin 53, while the end 54 facing away from the open margin 53 has a section 55 tapering like a hollow body, which leads into a funnel-shaped portion 69 with the opening 80. The discharge vessel 51 has in its interior a support 58 in the form of a quartz tube around which a coil of metal wire is wound on the hollow cylindrical portion 52 and serves as the first electrode 59. The margin 82 of the funnel-like portion 69 comprises an electrode-free prolongation 81 of the tubular support 58 along the longitudinal axis 57 for the interior or first electrode 59, and in the manufacturing process the margin 82 is sealed vacuum-tight by fusion to the portion of support 58 (prolongation 81) which passes through the opening 80. The connection of the first electrode 59 to the lead-through 76 through the base 61 is performed by means of a connecting bridge 60.

The material for the coil formed on the quartz tube serving as support is preferably nickel-chrome or nickel-chrome wire—as was already stated in reference to FIG. 1. It is also possible, however, to form the first electrode by applying a coating of conductive material or a metal mesh of monel metal or noble metal to the quartz tube.

In spite of the elongated internal electrode, in order to maintain sufficient stability during the annealing processes necessary during the manufacture of the radiator without resorting to external cooling, one end of the support 58 of the first electrode is inserted into the hollow body-like section 55 of the discharge vessel 1, which tapers as seen in longitudinal section, and is centered therein.

The end of support 58 toward the open end at the margin 53 of the discharge vessel 1 is connected to the base 61 which also consists of quartz glass, and which is fused, at its margin 62 facing the discharge vessel, to the circumferential margin 53 of the discharge vessel. The end 63 of the quartz glass tube or support 58 that is remote from the base 11 is inserted into the more or less conically tapering hollow body-like section 55 of the discharge vessel and thus it is held and centered along the axis 57 against radial shifting.

After the fusion of the circumferential margin 82 and the electrode-free portion of the support 58 (prolongation 82) a mechanically strong and gas-tight fixation of the support 58 is achieved thus it is only through an opening situated in the base area of the support 58 between the interior of the quartz tube and the discharge chamber 65 and, if desired, through lateral openings 70 in the quartz tube serving as support 58, that a gas connection can be made to the pumping and metering apparatus. This means that the atmosphere in the discharge chamber is evacuated from the discharge chamber through the portion of support 58 that protrudes from the discharge chamber and then it is provided with a gas filling for the discharge.

This means that the internal atmosphere of the discharge chamber 15 is first pumped out through prolongation 81 and replaced by a gas for the discharge—for example, xenon with a cold filling pressure of a few mbar up to 1 atmosphere, preferably a cold filling pressure of ≦300 mbar. It is also possible, however, to use as the filling gas a gas mixture containing noble gas. After the filling process the discharge vessel is hermetically sealed by a fusing or pinching process in the area of the prolongation 81 of the quartz glass tube.

The cross section of the embodiment in FIG. 3 is essentially the same as FIG. 2 as previously described.

In the embodiment according to FIG. 3 it is furthermore possible to use getter material.

The getter material can be inserted—for example, in the form of a short strip—into the elongated support for the quartz tube serving for the internal electrode and fastened by means of a slit in the quartz tube.

It is claimed:

1. Excimer radiator, especially ultraviolet radiator, with dielectrically impeded discharge, wherein, in a discharge chamber sealed against the ambient atmosphere, a first electrode is applied to an elongated support which, as seen radially spaced away from its longitudinal axis, is surrounded by a discharge vessel defining the discharge chamber and made of dielectric, radiation-permeable material, wherein a second electrode is disposed on the outside of the discharge vessel and is permeable for at least a part of the radiation produced in the discharge chamber, characterized in that one end of the support (8, 58) of the first electrode is placed and fixed in a hollow body-like section (5, 55) which tapers as seen in longitudinal section, while the other end of the support (8, 58) is connected with a base (11, 61) which has at least one electric current feed-through (16, 66) for the first electrode.

2. Excimer radiator according to claim 1, characterized in that the hollow body-like section (5, 55) tapers conically.

3. Excimer radiator according to claim 1 or 2, characterized in that the support (8) has an electrically insulating surface on which the material for the first electrode (9, 59) is applied.

4. Excimer radiator according to any one of claims 1 to 3, characterized in that the support (8, 58) has a cavity which is in gas-connection with the discharge chamber.

5. Excimer radiator according to claim 4, characterized in that the support (8, 58) is in the form of a quartz tube.

6. Excimer radiator according to any one of claims 1 to 5, characterized in that the base (11, 61) is hermetically bonded to a circumferential margin (3, 53) of the discharge vessel (1, 51).

7. Excimer radiator according to any one of claims 1 to 8,characterized in that the discharge vessel (1, 51) consists of quartz glass.

8. Excimer radiator according to claim 7, characterized in that the base (11, 61) consists of quartz glass and is connected by fusion with the discharge vessel (1) formed as a quartz glass flask.

9. Excimer radiator according to any one of claims 1 to 8, characterized in that an outwardly directed tubular section (6) is attached as a pump connection to the hollow body-like section (5) of the discharge vessel and is provided for the connection to a pumping and metering apparatus.

10. Excimer radiator according to claim 9, characterized in that the tubular section (6) consists of quartz.

11. Excimer radiator according to any one of claims 1 to 8, characterized in that the support (58) provided with an internal cavity reaches outward through a central opening (80) in the tapering, hollow body-like section (55), the central opening (80) being hermetically sealed by fusion to the outside surface of the brought-through portion of the support (58) and the brought-through portion of the support (58) is configured as a pump connection which is provided for connection to the pumping and metering apparatus.

12. Excimer radiator according to any one of claims 1 to 11, characterized in that the first electrode is disposed on the support (8, 58) as a spiral coil of a metal wire.

13. Excimer radiator according to claim 12, characterized in that the first electrode (9, 59) is in the form of a coil of nickel chrome wire.

14. Excimer radiator according to any one of claims 1 to 11, characterized in that the first electrode is disposed as a metal mesh on the support (8, 58).

15. Excimer radiator according to claim 14, characterized in that the first electrode consists of monel metal.

16. Excimer radiator according to any one of claims 1 to 11, characterized in that the first electrode (9, 59) is applied as an electrically conductive coating on the support (8, 58).

17. Excimer radiator according to claim 16, characterized in that the applied coating has essentially metal, especially noble metal.

18. Excimer radiator according to any one of claims 1 to 17, characterized in that the second electrode is disposed as metal mesh on the outside surface of the discharge vessel (1, 51).

19. Excimer radiator according to claim 18, characterized in that the applied metal mesh consists essentially of monel metal.

20. Excimer radiator according to any one of claims 1 to 17, characterized in that the second electrode is disposed as a spiral metal coil on the outside surface of the discharge vessel (1, 51).

21. Excimer radiator according to claim 20, characterized in that the second electrode consists of nickel-chrome wire.

22. Excimer radiator according to any one of claims 1 to 17, characterized in that the second electrode is applied at least partially as an electrically conductive coating on the outside surface of the discharge vessel (1, 51).

23. Excimer radiator according to claim 22, characterized in that the second electrode contains essentially metal, especially noble metal.

24. Excimer radiator according to any one of claims 4 to 23, characterized in that the cavity of the support (8, 58) is provided for the accommodation of getter material.
